(19) United States
(12) Patent Application Publication
(10) Pub. No.: US 2007/0107252 A1
(43) Pub. Date: May 17, 2007

(54) Vacuum extraction unit for a device used to structure the surface of a workpiece by means of radiation

(75) Inventors: Klaus Kruckenhauser, Langkampfen (AT); Josef Juffinger, Thiersee (AT)

Correspondence Address: BIRCH STEWART KOLASCH & BIRCH, PO BOX 747, FALLS CHURCH, VA, 22040-0747, US

(73) Assignee: Stork Prints Austria GmbH, Langkampfen (AT)

(21) Appl. No.: 10/580,275

(22) PCT Filed: May 5, 2004
(86) PCT No.: PCT/EP04/04789

§ 371 Date: Jul. 18, 2006

(30) Foreign Application Priority Data
Nov. 27, 2003 (DE) 103 55 996.5

(51) Int. Cl. B08B 5/04; F26B 5/04

(52) U.S. Cl. 34/402; 134/21

(57) ABSTRACT

The invention relates to a vacuum unit for a device used to structure the surface of a workpiece (20), in particular a plate such as e.g. a flexographic printing block, by means of radiation and especially laser radiation. Said unit comprises a hood (10), which in its operating position covers an interaction zone between the radiation and the surface of the workpiece, consisting of a rear face (11), to which a vacuum line (38) can be connected, two lateral walls (16) comprising end edges (19), which lie opposite the workpiece (20) in the operating position of the hood (10), and two leading walls (17, 18), which are located between the lateral walls (16), run transversally to the latter and which together with the two lateral walls (16) delimit a vacuum channel (14) in the hood (10), said channel comprising an inlet (15), which lies opposite the workpiece (20) in the operating position of said hood (10). The aim of the invention is to provide a vacuum unit of the aforementioned type, which permits abraded or decomposition products that form during the engraving process, such as aerosols, water vapour and fumes, in addition to centrifugal particles, to be reliably removed from the interaction zone between the laser beam and the workpiece, thus practically eliminating a build-up of said products on the workpiece and/or vacuum unit. To achieve this, the edge (21) of one (17) of the two leading walls lies opposite the workpiece in the operating position of the hood (10), whilst the other leading wall (18) comprises a convex, cylindrical curvature lying opposite the surface of the workpiece in the operating position of the hood and, in the vicinity of the curvature, at least one opening (23), through which the radiation for engraving the workpiece surface is guided.

The invention relates to a vacuum extraction unit for a device used to structure the surface of a workpiece, in particular a printing form, such as for example a flexographic printing block, by means of radiation, in particular by means of laser radiation.

The engraving of a relief into a surface of a workpiece by means of radiation, in particular by means of laser radiation, is used in particular for the production of flexographic printing forms, a printing relief being engraved by a laser beam directly into the relief-forming layer of a flexographic printing element, so that there is no longer any need for the flexographic printing element to be developed, as is required in phototypesetting processes.

In the case of laser engraving, the regions to be recessed are exposed to laser radiation in such a way that the material of the blank is removed there. The constituent parts to be removed are thereby vaporized and/or decomposed, so that their abrasion or decomposition products take the form of vapors, hot gases, fumes, aerosols and/or small particles.

In particular if the flexographic printing blank to be engraved is a cylinder or a plate which is to be fastened on a cylindrical carrier for engraving, and the cylinder is rotated at high speeds during the engraving, it is required that these decomposition products are removed as completely as possible from the region where they are created, in order to prevent them from becoming lodged in already engraved regions and impairing the fineness of the engraved pattern there. Furthermore, the decomposition products may also be deposited on regions that are not engraved and disturb the engraving process there or else soil the laser beam guiding elements, which likewise leads to an impairment of the engraving quality.

DE 299 80 010 U1 already discloses a processing head for a laser engraving or cutting device in which a nozzle-like lens holder, holding the focusing lens, is surrounded by a vacuum extraction hood, which is connected via a vacuum extraction line to a corresponding vacuum extraction unit. The processing head is equipped with at least two gas nozzles, one of which directs a gas jet obliquely into a region of a zone of interaction between the laser beam and the stamping plate to be engraved, while the other likewise directs an oblique gas jet against the stamping plate to be engraved, which impinges in the region between the processing point and the edge of the vacuum extraction hood in order to retard the radial spread of dust or other decomposition products during the processing of the stamping plate, so that they can be extracted via the vacuum extraction hood and not escape through a gap at the edge of the same.

EP 0 427 004 A2 discloses a device for processing hollow cylinders, in particular screen stencils, by means of a laser, in which the hollow cylinder to be processed is supported by rolls or tapered supporting rollers in its axial direction upstream and downstream of a zone of interaction between the laser beam and the hollow cylinder, that is to say upstream and downstream of an engraving site. In the case of this device, the laser processing head is preceded by a vacuum housing which is formed in such a way that the mouthpiece of the laser processing head is surrounded by the vacuum housing. This forms a vacuum chamber with an opening, the edge of which forms with the engraving cylinder a gap which surrounds the engraving region, that is the zone of interaction between the laser beam and the stencil. Since air flowing in via the gap from the vacuum chamber is constantly extracted, the pressure difference between the surrounding atmosphere and the interior of the vacuum chamber is maintained, forcing the stencil into constant contact with the rolls or tapered supporting rollers.

The extraction of the air from the vacuum chamber, which serves the purpose of ensuring the pressure difference for the secure contact of the stencil against the supporting elements, is not sufficient however for the removal of abrasion and/or decomposition products.

EP 0 562 149 A1 further discloses a device for processing thin-walled hollow cylinders by means of a laser beam, in which a laser processing head is arranged alongside a hollow cylinder that is rotatably mounted about its longitudinal axis, such as for example a blank for a screen stencil or the like, on a carriage which is displaceable parallel to the longitudinal axis of the hollow cylinder to be processed. Along with the laser processing head, a supporting bearing for the hollow cylinder is fixedly mounted on the carriage, so that it can be moved together with the carriage in the axial direction of the hollow cylinder.

The supporting device comprises a lower bearing bracket substantially in the form of a half-circle and an upper bearing bracket in the form of a quarter-circle, which is pivotably mounted to permit the automatic loading of a hollow cylinder.

The lower bearing bracket, which may be equipped with a multiplicity of bearing rollers, has a substantially U-shaped profile, which is closed at the extreme ends so as to form a suction channel, which can be connected by means of a corresponding vacuum extraction connecting piece to a suitable vacuum extraction unit in order to produce a slight negative pressure in the suction channel, which ensures that the hollow cylinder is kept in reliable contact with the lower bearing bracket of the supporting device, in order to ensure reliable, vibration-free guidance of the hollow cylinder in its respective processing region, so that precise laser processing is possible.

However, means by which abrasion or decomposition products are removed from the processing region, that is from the zone of interaction between the laser beam and the hollow cylinder, are not shown here.

The invention is based on the object of providing a further vacuum extraction unit of the type mentioned at the beginning with which abrasion and/or decomposition products can be reliably removed from the region of interaction between the laser beam and the workpiece, so that depositing of these products on the workpiece and/or the vacuum extraction unit is prevented virtually completely.

This object is achieved by the vacuum extraction unit as claimed in claim 1 or 2. Advantageous refinements and developments are described in the respective subclaims.

Therefore, in the case of a vacuum extraction unit which has a hood, which in its operating position covers a region of interaction between the radiation and the workpiece surface, it is provided according to the invention that the hood has a rear side, to which a vacuum extraction line can be connected, two side walls, which have end edges which lie opposite the workpiece in the operating position of the hood, and two directing walls, which are located between the side walls, extend transversely in relation to the latter and which together with the two side walls delimit in the hood a vacuum extraction channel with an inlet opening, which lies opposite the workpiece in the operating position of the hood, an edge of one of the two directing walls lying opposite the workpiece in the operating position of the hood, while the other directing wall has a convex, cylindrical curvature lying opposite the workpiece surface in the operating position of the hood and, in the region of this curvature, at least one opening, through which the radiation for processing the workpiece surface is guided.

The way in which the hood of the vacuum extraction unit is configured according to the invention, in particular the convex cylindrical curvature with which one of the two directing walls of the vacuum extraction channel lies opposite the region of interaction between the radiation and the workpiece surface, produces a smooth, vortex-free, very rapid air flow in this region, which entrains the particles and/or decomposition products that are detached from the workpiece surface in the region of interaction or engraving region and removes them through the vacuum extraction channel. In this way, particles and/or decomposition products that are detached from the workpiece, such as for example aerosols or the like, are prevented from being able to settle on the workpiece. Consequently, even very fine structures can be engraved in the workpiece surface, as required more and more in the case of printing stencils for example, in particular in the case of flexographic printing forms.

In the production of flexographic printing forms or blocks, the vacuum extraction unit according to the invention also permits in particular the extraction of tacky aerosols, which are produced along with fumes and vapor during the engraving of flexographic printing blanks by means of laser radiation. If they are deposited in the engraved regions, such tacky aerosols can only be washed out with difficulty, and consequently considerably impair fine structures of a printed image in particular.

According to another aspect of the invention, in the case of a vacuum extraction unit which has a hood, which in its operating position covers a region of interaction between the radiation and the workpiece surface, it is provided according to the invention that the hood has a rear side, to which a vacuum extraction line can be connected, two side walls, which have end edges with a contour which is adapted to the contour of the surface of a workpiece to be processed, so that corresponding gap seals are formed when the end edges lie opposite the workpiece in the operating position of the hood, and two directing walls, which are located between the side walls, extend transversely in relation to the latter and which together with the two side walls delimit in the hood a vacuum extraction channel with an inlet opening, and furthermore the hood has at least one opening, through which the radiation for processing the workpiece surface is guided.

The adaptation of the side walls to the workpiece contour allows lateral air inflow regions to be reduced to such an extent as to form in practice gap seals through which air which could disturb the air flow conditions inside the hood is scarcely sucked in. Consequently, a rapid air flow is possible without vortices occurring, so that the amount of abrasion and decomposition products that are transported away is increased.

In the case of a preferred development of the invention, it is provided that the curvature of the curved directing wall is curved in the form of an arc of a circle, the curving of the curvature of the curved directing wall advantageously being greater than the curving of the surface of the workpiece.

The curvature of the curved directing wall may, however, also be exponentially curved, in order to set specific velocity profiles of the flow in the vacuum extraction channel.

An expedient development of the invention is distinguished by the fact that the opening or openings through which the radiation for processing the workpiece is guided is/are provided in the region of the curved directing wall that lies closest to the surface of the workpiece in the operating position of the hood.

To form gap seals that are as effective as possible, it is expedient if the contour of the end edges of the side walls is a polyline or an arc of a circle that is adapted to the contour of the workpiece surface.

An advantageous refinement of the invention is distinguished by the fact that the distance between the end edges of the side walls and the workpiece surface in the operating position of the hood is less than 50 mm, preferably less than 30 mm, in particular less than 10 mm but greater than 0.5 mm, and with particular preference between 1 mm and 5 mm, the width of the gap seals formed between the end edges of the side walls and the workpiece surface lying in the range between 0.1 mm and 30 mm.

In order to ensure effective lateral sealing by the gap seals in the case of different workpiece contours, in particular in the case of different workpiece diameters, it is provided that the hood is exchangeably fastened to a working laser head, so that when processing cylindrical workpieces with different diameters a hood from a number of hoods is respectively chosen and fastened to the working laser head, the side walls of which hood have end edges with a contour which is adapted as well as possible to the contour of the surface of the workpiece respectively to be processed.

A preferred refinement of the invention is distinguished by the fact that the side walls of the hood are provided with means, in particular movable lamellae or exchangeable side parts, by which the contour of the edges of the side walls that lie opposite a workpiece can be changed in order to adapt them to the surface of the workpiece.

In the case of another refinement of the invention, it is advantageously provided that, in the region of the curved directing wall that lies closest to the surface of the workpiece in the operating position of the hood, each working jet or beam delivered by a processing head, in particular each working laser beam delivered by a working laser head, is provided with an opening of its own, through which the radiation for processing the workpiece is focused on the latter.

In order also to allow decomposition products such as fumes, vapor and the like that are created outside the covering region of the hood to be extracted, it is also provided that a C-shaped cover ring which has two ends that follow the circumference of the workpiece and are located at a distance from each other and which has a substantially U-shaped cross section is provided, the hood being arranged adjacent one of the two circumferential ends of the cover ring.

The C-shaped cover ring may in this case extend partially or virtually completely around a cylindrical workpiece. In the latter case, its two circumferential ends lie adjacent the hood. In the former case, it may extend over 90°, 120°, 180° or any other angular range which is sufficient to allow fumes, vapors, small particles or the like to be captured and extracted.

Furthermore, it is expedient if the C-shaped cover ring is exchangeable, so that when processing cylindrical workpieces with different diameters a cover ring from a number of cover rings can be respectively chosen and used, the inside diameter of which ring is adapted as well as possible to the diameter of the cylindrical workpiece respectively to be processed.

However, it is also possible that the side walls of the C-shaped cover ring are provided with means for reducing its free inside diameter, so that said ring can be set to correspond to the diameter of the cylindrical workpiece respectively to be processed.

The means for reducing the free inside diameter of the C-shaped cover ring in this case advantageously comprise a lamellar seal, the individual lamellae of which are pivotably fastened to the side walls of the cover ring.

The means for reducing the free inside diameter of the C-shaped cover ring may, however, also be formed by exchangeable side parts, in particular side plates.

In the case of a preferred refinement of the invention, it is provided that the C-shaped cover ring is circumferentially subdivided into at least two ring segments, which are pivotably held against each other. In this case it is preferred for the C-shaped cover ring to be circumferentially subdivided into three ring segments of different circumferential lengths, the circumferential length of an upper ring segment corresponding approximately to half the circumferential length of the cover ring, while the lower ring portion has two shorter ring segments.

To improve the extraction further, it is expedient if a vacuum extraction nozzle is arranged in an intermediate space between the hood and a circumferential end of the C-shaped cover ring that is located upstream of the hood.

The invention is explained below by way of example on the basis of the drawing, in which:

FIG. 1 shows a perspective front view of a hood of a vacuum extraction unit according to the invention;

FIG. 2 shows a perspective rear view of the hood as shown in FIG. 1;

FIG. 3 shows a section through a vacuum extraction unit according to the invention in its operating position in relation to a cylindrical workpiece to be processed;

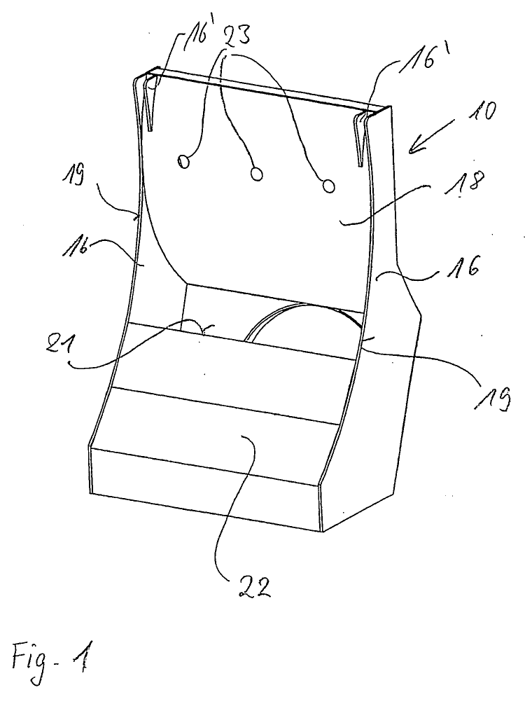

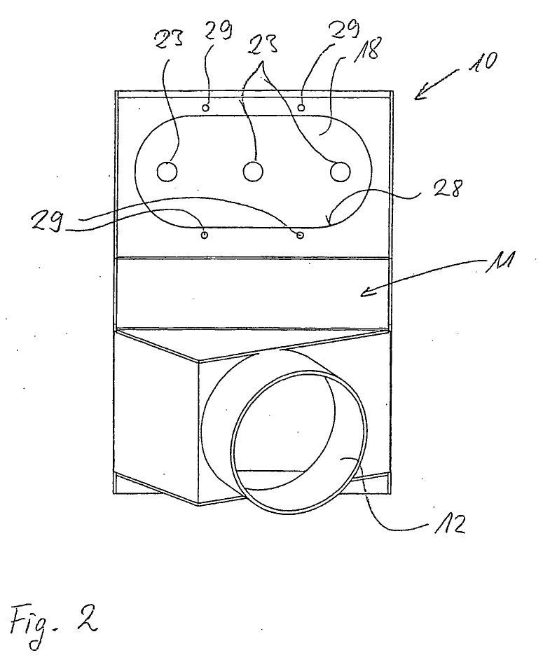

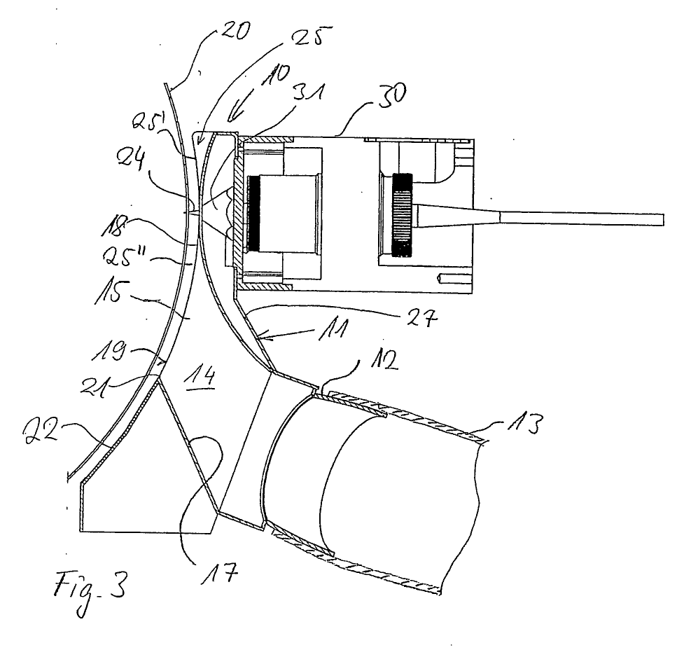

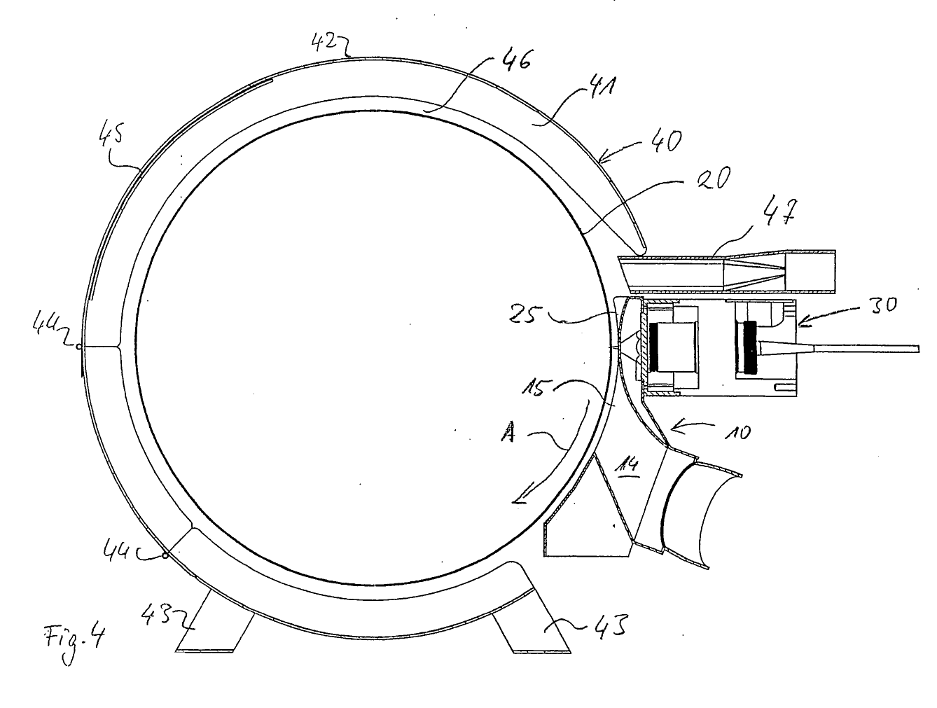

FIG. 4 shows a section through a vacuum extraction unit according to a second exemplary embodiment of the invention, the head being shown with an assigned working laser head in its operating position in relation to a cylindrical workpiece with a large diameter;

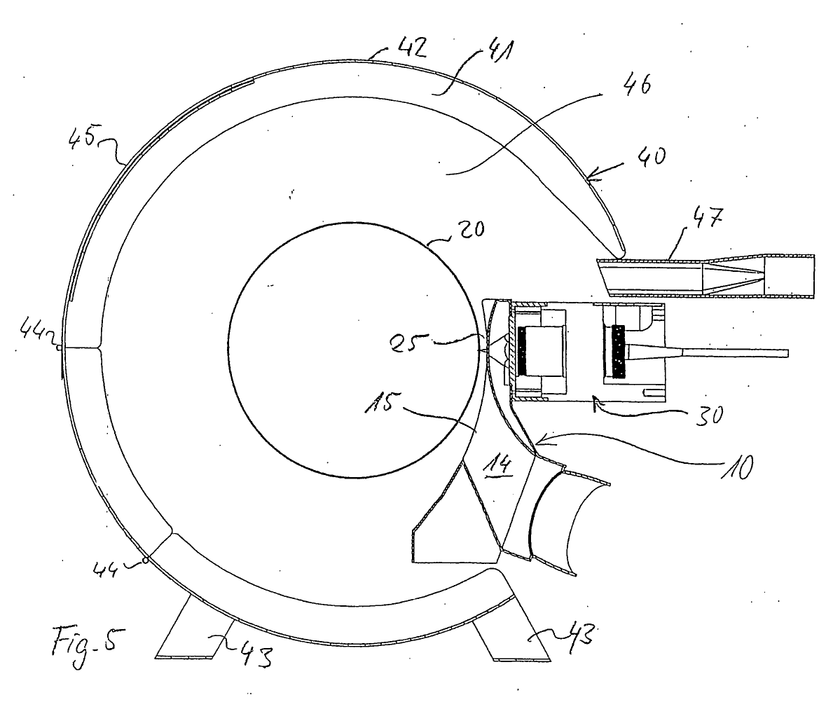

FIG. 5 shows a section corresponding to FIG. 4, the hood together with the working laser head assuming an operating position in relation to a cylindrical workpiece with a smaller diameter;

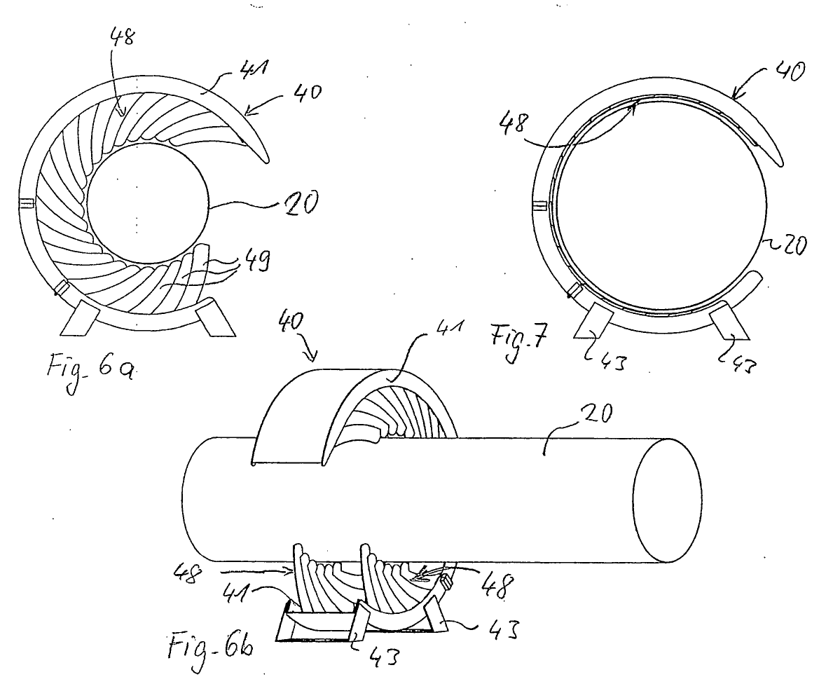

FIG. 6a shows a side view of a development of a cover ring for a vacuum extract-on unit according to the invention as shown in FIGS. 4 and 5 with a cylindrical workpiece of a smaller diameter;

FIG. 6b shows a perspective view of the arrangement according to FIG. 6a;

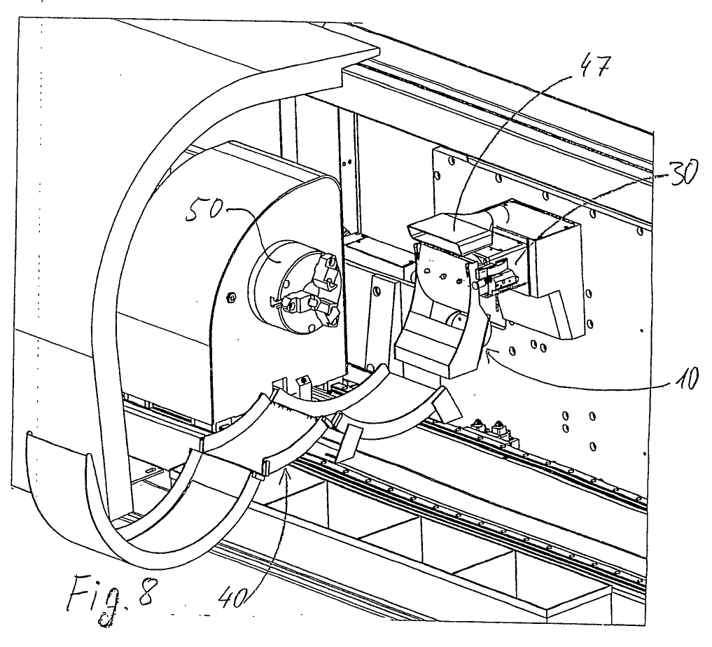

FIG. 7 shows a side view of the cover ring of the vacuum extraction unit according to the invention as: shown in FIGS. 4 and 5 together with a cylindrical workpiece of a larger diameter;

FIG. 8 shows a perspective representation of the vacuum extraction unit according to the invention as shown in FIGS. 4 and 5 with a pivoted-open cover ring;

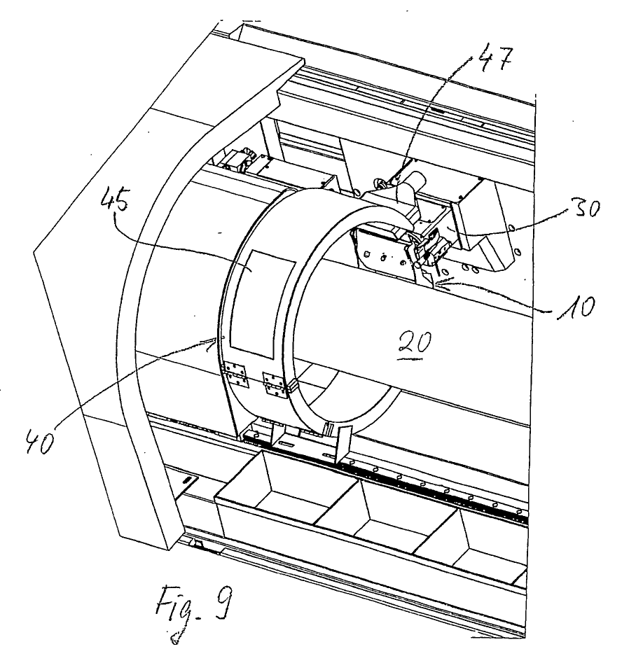

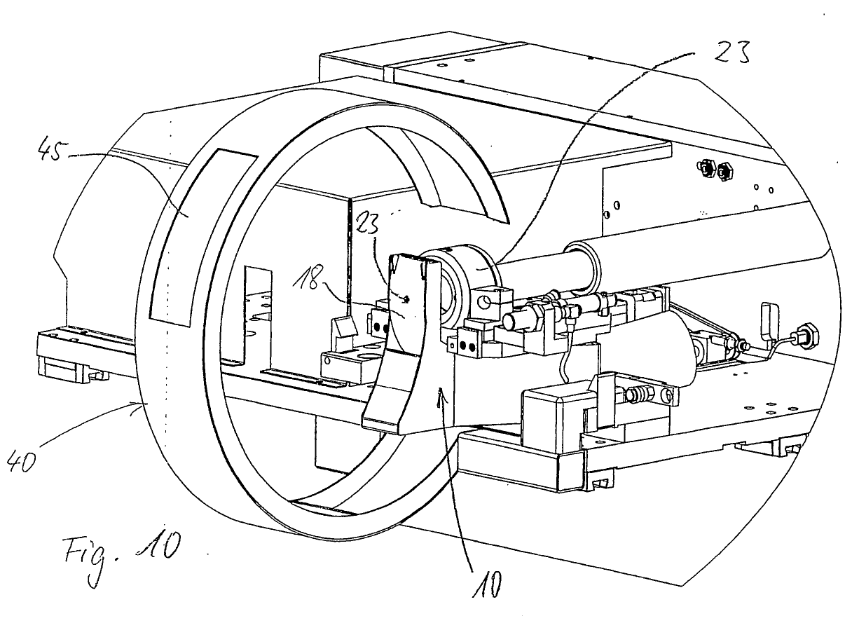

FIG. 9 shows a perspective representation of the vacuum extraction unit as shown in FIGS. 4 and 5, a cylindrical workpiece with a smaller diameter having been loaded, while the extraction hood is still located in a position of readiness; and

FIG. 10 shows a perspective representation of a further vacuum extraction unit for a working laser head with only one processing jet or beam and a one-part, fixed cover ring.

In the various figures of the drawing, components that correspond to one another are provided with the same designations.

As represented in FIGS. 1, 2 and 3, the vacuum extraction unit according to the invention comprises as the main element a hood 10, attached to the rear side 11 of which is a connecting piece 12 for a vacuum extraction line 13, which is only schematically indicated in FIG. 3. Through the hood 10 there extends a vacuum extraction channel 14, which extends from an inlet opening 15 to the connecting piece 12 and which is delimited by two side walls 16 and two directing walls 17, 18, which are located between the side walls 16 and extend transversely in relation to the latter. The two side walls 16 have end edges 19 which laterally delimit the inlet opening 15 and the contour of which is adapted substantially to the contour of a workpiece to be processed by means of radiation.

In the exemplary embodiment represented, the workpiece has a cylindrical shape with a circular cross section. Accordingly, the end edges 19 have a contour substantially in the form of an arc of a circle, which is adapted to the circumference of the workpiece 20 so as to form between the end edges 19 and the workpiece 20 a gap seal, the sealing effect of which is all the better the smaller the distance between the end edges 19 and the surface of the workpiece 20 is and the wider the end edges 19 are.

This distance is expediently less than 50 mm, preferably less than 30 mm, and should be between 0.5 mm and 10 mm, in particular between 1 mm and 5 mm. In order to improve the sealing effect of the gap seals formed by the end edges 19 of the side walls 16 with the surface of the workpiece 20, it may be provided that the end edges 19 have a greater width in the axial direction of the cylindrical workpiece. The greater width of the end edges 19 may in this case be brought about simply by a greater thickness of the side walls 16. However, it is also possible to provide the side walls 16 with a flange extending away from the inlet opening 15, in order to form wider gap seals. The width of the end edges 19 or of the flanges widening them in this case expediently lies in a range from 0.1 mm to 20 or 30 mm.

In order to keep the distance between the end edges 19 and the surface of the workpiece 20 in the desired range even when cylinders with different diameters are to be processed, different hoods may be provided, the side walls of which have end edges with curvatures respectively adapted to a specific diameter range. However, it is also conceivable to provide the side walls with adjustable lamellar compartments or the like, which in the case of greater distances between the end edges and the workpiece surface can be moved close to the latter.

The lower directing wall 17 in the drawing lies opposite the surface of the workpiece 20 with an edge 21, which is adjoined by a wall 22, which extends away from the inlet opening 15, extends between the side walls 16 and the surface of which that lies opposite the workpiece has a concave curvature corresponding to the contour of the end edges 19 of the side walls 16. The wall 22 consequently forms with the surface of the workpiece 20 a further gap seal, delimiting the inlet opening 15.

In order to prevent decomposition products from becoming lodged at the edge 21 of the lower directing wall 17 or the wall 22, said edge is formed as a sharp edge.

The upper directing wall 18 in the drawing has a convexly curved surface lying opposite the workpiece 20, the curved directing wall 18 having at least one opening 23 where it lies closest to the workpiece 20 on account of its curvature, through which opening radiation for processing the workpiece surface, preferably a working laser beam 24, is guided (see FIG. 3). The curved directing wall 18 forms together with the workpiece 20 a suction gap 25, the narrowest point of which lies in the region of the openings 23 for the working laser beam to pass through, and consequently in the area of a region of interaction between the working laser beam 24 and the workpiece 20. However, it is also possible to arrange this narrowest region of the suction gap 25 slightly upstream of the interaction or engraving region with respect to the air flow that is sucked in through the gap. The opening or openings 23 are in this case designed to be so small that they do not hinder the radiation but also do not disturb the flow.

The suction gap 25 comprises upstream of its narrowest point in the direction of flow a portion 25′ which narrows in the form of a funnel in the cross section in FIG. 3 and downstream of the constriction in the direction of flow a portion 25″ which widens once again in the form of a funnel. The convex curvature of the curved directing wall 18 may in this case curve for example in the form of an arc of a circle. However, it is also possible for the curving of the curvature of the curved directing wall 18 to be chosen to correspond to the contour of the workpiece 20 in such a way that the velocity of the air flow in the constriction of the suction gap 25 is high enough to entrain abrasion and decomposition products that are present there. Downstream of the constriction of the suction gap 25, the flow velocity should continue to remain high enough that it is not possible in practice for the entrained abrasion and decomposition products to settle.

As can be seen in FIG. 1, directing ribs 16′ extending in the direction of flow are provided in the region of the portion 25′ of the suction gap 25, adjacent but at a small distance from the side walls 16, in order to further smooth the air flow flowing in.

Furthermore, it is conceivable that the curvature of the curved directing wall is exponentially curved, in order to set specific velocity profiles of the flow in the vacuum extraction channel, which for example permit higher flow velocities and consequently prevent to the greatest extent decomposition products from being deposited.

As a result of the described geometry of the suction gap 25 and on account of the gap seals formed by the side walls 16 and the wall 22, during vacuum extraction operation air is primarily sucked in through the suction gap 25 into the inlet opening 15 of the vacuum extraction channel 14. In the process, the flow sucked in is greatly accelerated on account of the narrowing gap, so that at the constriction of the suction gap 25 it can achieve extremely high flow velocities of up to about 150 to 180 m/s or higher. Apart from the high flow velocities, the structure of the hood 10 of the vacuum extraction unit according to the invention, that is in particular the structure of the walls 16, 17, 18 delimiting the vacuum extraction channel 14 and the structure of the gap seals delimiting the inlet opening 15 together with the suction gap 25, ensures that a smooth flow with high flow velocities and without vortices occurs in the suction gap 25 in particular, permitting abrasion and decomposition products such as aerosols, fumes, vapor and the like to be reliably transported away from the engraving region during the processing of the workpiece 20.

As can be seen in FIGS. 2 and 3, provided on the rear side 11 of the hood 10 is a mounting wall 27 with a mounting opening 28 and fastening openings 29, with which the hood 10 can be fastened to a working laser head 30, in particular in an exchangeable manner, in such a way that a nozzle-shaped outlet portion 31 for a working laser beam, or according to the exemplary embodiment represented three working laser beams 24, protrude(s) through the mounting opening 28 and lie(s) opposite the openings 23 in the curved directing wall 18 in such a way that the laser beam or beams 24 can be focused on the workpiece surface through the openings 23.

In order to engrave a relief into the surface of a workpiece, in particular into the surface of a cylindrical workpiece, such as for example a cylindrical printing stencil or cylindrical flexographic printing form, by means of radiation, the cylindrical workpiece 20 is rotated about its axis, while at the same time a relative movement between the working laser head 30 and the cylindrical workpiece 20 takes place in the axial direction. For this purpose, depending on the configuration of the processing device, either the cylindrical workpiece 20 may be displaced with respect to the fixed working laser head 30, or else it is conceivable that the cylindrical workpiece 20 is mounted such that it is fixed in the axial direction, while the working laser head 30 is displaced parallel to the workpiece axis. As a result of the rotational movement of the cylindrical workpiece 20 being superposed with the relative axial movement, it is possible in accordance with the desired relief for each point of the workpiece surface to be exposed to a correspondingly pulsed working laser beam 24, which is focused for this purpose on the surface of the workpiece 20.

Depending on which amounts of decomposition products and abraded material are to be reliably transported away during the laser processing, in particular laser engraving, not only must a rapid gas flow be achieved in the engraving region, but a sufficiently high volumetric flow rate must also be ensured. In this respect it must be taken into account that, with a rapid flow and high volumetric flow rate of the waste air, the decomposition products transported by it out of the engraving region tend to be deposited on the surface of the workpiece 20 or on the walls of the vacuum extraction channel 14 all the less the higher the flow velocity is and the lower the amount of material to be transported per cubic meter of volumetric flow is. It is therefore generally recommendable to use a volumetric flow rate of the waste air of at least 0.1 m³/g of degraded material. With preference, the volumetric flow rate is at least 0.5 m³/g, in particular at least 1.0 m³/g. In the case of a laser apparatus of average size, as is used in particular for the direct engraving of flexographic printing forms, engraving is carried out for example at a rate of 1 m²/h, which produces material abrasion of 500 to 1000 g/m². Accordingly, the vacuum extraction unit according to the invention should operate at an extraction rate of at least 50 to 100 m³/h, preferably at at least 250 to 500 m³/h and in particular at at least 500 to 1000 m³/h or more.

Consequently, with the vacuum extraction unit according to the invention, as described on the basis of FIGS. 1 to 3, abrasion and decomposition products can be reliably removed from the engraving region, that is from the region of interaction between the working laser beam 24 and the workpiece surface, such high extraction rates and volumes being achieved that settling of decomposition products and abraded material can be prevented both on the workpiece surface and in the vacuum extraction channel. In particular by making the edge 21, which is formed by the lower directing wall 17 and the wall 22, take the form of a sharp edge, aerosols and other abraded material are prevented from being deposited on it.

If this vacuum extraction unit according to the invention is used when engraving materials which continue to glow for a short time after exposure to the laser, which however at the high processing speeds, that is the high rotational speeds of the cylinders to be processed, leads to engraved regions continuing to glow over a quarter or even half revolution of the cylindrical workpiece 20, fumes develop not only in the engraving region and in the region of the inlet opening 15 of the vacuum extraction channel 14 but also beyond them.

In order to prevent such fumes from getting into the surroundings, it is possible for example to encapsulate the entire laser engraving unit. Although such encapsulation prevents the fumes and the like from getting into the environment, this does not avoid soiling of the machine.

According to a second refinement of the present invention, the described vacuum extraction unit, as represented in FIG. 4, is therefore used together with a substantially C-shaped cover ring 40, which has a substantially U-shaped profile with side walls 41 lying opposite each other and a bottom wall 42, which connects the side walls 41 to each other in the outer circumferential region of the cover ring 40. Although it is conceivable that such a cover ring 40 is moved together with the laser processing head 30 and the hood 10 along a fixed cylindrical workpiece 20, it is preferred to mount the cover ring 40 of the vacuum extraction unit according to the invention by means of supports 43 on a machine bed of the laser processing or engraving machine, so that it is fixedly fastened on the machine in the same way as the laser working head 30. The cover ring 40 is therefore always arranged in the region of the laser processing head 30 with respect to the axial direction of the cylindrical workpiece 20, that is in the region of the zone of interaction between the radiation and the workpiece, irrespective of whether it is displaced together with the laser working head 30 or, like the latter, is fixedly mounted.

The cover ring 40 may in this case be formed as an undivided ring, as is represented for example in FIG. 10. It is preferred, however, that the cover ring 40 comprises two segments or, as represented in FIG. 4, three segments, which are connected to one another by means of hinges 44 in such a way that the cover ring 40, as represented in FIG. 8, can be pivoted open toward the front side of the machine, so that a cylindrical workpiece 20 can be loaded easily, and preferably automatically, into the engraving machine. After loading a symmetrical workpiece into the engraving machine, that is after the workpiece 20 is held on corresponding clamping jaws 50, one of which is shown in FIG. 8, the cover ring 40 is closed, as is represented in FIGS. 4, 5 and 9 for cylindrical workpieces 20 of different diameters.

In FIG. 9 it can be seen in the same way as in FIG. 10 that the cover ring 40 according to the invention is equipped with a viewing window 45, through which the processing operation can be visually monitored.

During processing of the workpiece 20, the latter is rotated at high speed in the direction of the arrow A in FIG. 4, while material is abrasively removed from the surface by a pulsed working laser beam 24. The vacuum extraction unit according to the invention causes primarily air to be sucked out of the region upstream of the suction gap 25, that is from the region above the hood 10, via the suction gap 25 and the inlet opening 15 of the vacuum extraction channel 14.

On account of the rotation of the cylindrical workpiece 20 at high speed, an air flow is created around the workpiece 20 in the direction of rotation. This air flow also exists within an annular channel formed between the cover ring 40 and the workpiece surface 20. Since, seen in the direction of rotation of the workpiece 20, the air is extracted through the vacuum extraction gap 25 from the annular channel at the end of the latter between the cover ring 40 and the workpiece 20, and since a certain extraction of air also takes place in the region of the beginning of the annular channel via the gap seal between the wall 20 of the hood 10 and the workpiece surface, but is much less than the air sucked in via the suction gap 25, a certain negative pressure also already occurs at the entry to the annular channel between the cover ring 40 and the workpiece 20, so that a negative pressure that leads to air being sucked in via the annular gaps 46 prevails in the entire annular channel, thereby preventing fumes that are created by continued glowing of the processed material over a quarter or half revolution of the workpiece 20 or more from being held in the annular channel formed by the cover ring 40 and removing them via the vacuum extraction channel 14 in the hood.

In order to improve the extraction of air, in particular at the end of the annular channel formed by the cover ring 40, an additional vacuum extraction nozzle 47 may be arranged there, as represented in FIG. 4. This vacuum extraction nozzle 47 is of advantage in particular when, as represented in FIG. 5, a workpiece 20 with a significantly smaller diameter is to be processed.

Although it is provided in principle that, during the processing of cylindrical workpieces with a smaller diameter, a correspondingly adapted hood 10 of the vacuum extraction unit is also used, or a hood 10 of which the side walls 16 can be changed with the aid of suitable movable lamellae or exchangeable side plates with correspondingly adapted end edges, in order to keep the corresponding gap seals a small as possible, for the sake of simplicity the same hood 10 as in FIG. 4 is shown in FIG. 5.

In order to ensure reliable extraction of the air from the annular channel between the workpiece 20 and the cover ring 40 also when processing a cylindrical workpiece 20 with a smaller diameter, the vacuum extraction nozzle 47 is left in the outer region of the annular channel, while air is extracted from the inner region of the annular channel via the suction gap 25.

In order in this case to ensure that no fumes escape to the outside via the now very wide annular gap 46 between the side walls 41 and the surface of the workpiece 20, the cover ring 40 is equipped with lamellar seals 48, as represented in FIGS. 6a, 6b and 7, the individual lamellae 49 of which are pivotably held on the side walls 41 of the cover ring 40. With the aid of the lamellar seals 48, the gap 46 can consequently be covered apart from a narrow region near the surface of the cylindrical workpiece 20, so that fumes created by continued glowing can be reliably kept under the cover ring 40 and then extracted. The lamellar seals 48 may also be formed in the manner of iris diaphragms, as are known for example from optical diaphragms.

However, it is also possible to use exchangeable cover rings 40, which have different free inside diameters, so that a suitable cover ring 40 can be respectively chosen to correspond to the workpiece diameter. Furthermore, it is also possible to provide exchangeable side plates, which can be attached to the side walls 41 of the cover ring 40, in order if appropriate to reduce the size of the gap 46 in the way required and/or desired.

As represented in FIGS. 6a and 6b, the lateral sealing of the annular channel formed between the cover ring and the workpiece outside the region of the working laser head 30 and the hood 10 of the vacuum extraction unit can also be adapted to every workpiece diameter (not represented in FIGS. 6a, 6b and 7). FIG. 7 shows here the lamellar seal 48 in its fully retracted position, while FIGS. 6a and 6b show it in a far extended state.

The vacuum extraction unit according to the invention has so far been described together with a working laser head 30 which delivers three working laser beams 24 for processing a workpiece 20. However, it is also possible to use the vacuum extraction unit according to the invention with a working laser head 30 which provides more or fewer than three beams for the processing of the workpiece. For example, in FIG. 10 there is shown a hood 10 of a vacuum extraction unit according to the invention which has only a single opening 23 in its curved directing wall 18, and is consequently intended for use on a working laser head 30 which delivers only a single working laser beam.

The vacuum extraction unit according to the invention is not restricted to use on processing machines for the processing, in particular engraving, of printing forms or the like, but can be used everywhere where, during the laser processing of a workpiece, decomposition and abrasion products have to be extracted from the region of the zone of interaction between a radiation and a workpiece.

Although the exemplary embodiments represented are all designed for use during the processing of cylindrical workpieces, the device according to the invention can also be adapted for the processing of planar workpieces, in which a relative movement between the working laser head and the workpiece takes place.

1. A vacuum extraction unit for a device used to structure the surface of a workpiece (20), in particular a printing form, such as for example a flexographic printing block, by means of radiation, in particular laser radiation, with
a hood (10), which in its operating position covers a region of interaction between the radiation and the workpiece surface, with
a rear side (11), to which a vacuum extraction line (13) can be connected,
two side walls (16), which have end edges (19) which lie opposite the workpiece in the operating position of the hood, and
two directing walls (17, 18), which are located between the side walls (16), extend transversely in relation to the latter and which together with the two side walls (16) delimit in the hood (10) a vacuum extraction channel (14) with an inlet opening (15), which lies opposite the workpiece in the operating position of the hood, an edge (21) of one (17) of the two directing walls lying opposite the workpiece (20) in the operating position of the hood (10), while the other directing wall (18) has a convex, cylindrical curvature lying opposite the workpiece surface in the operating position of the hood and, in the region of this curvature, at least one opening (23), through which the radiation for processing the workpiece surface is guided.

2. The vacuum extraction unit as claimed in claim 1, characterized in that the end edges (19) of the two side walls (16) have a contour which is adapted to the contour of the surface of a workpiece (20) to be processed, so that corresponding gap seals are formed when the end edges (19) lie opposite the workpiece (20) in the operating position of the hood (10).

3. The vacuum extraction unit as claimed in claim 1, characterized in that the curvature of the curved directing wall (18) is curved in the form of an arc of a circle.

4. The vacuum extraction unit as claimed in claim 3, characterized in that the curving of the curvature of the curved directing wall (18) is greater than the curving of the surface of the workpiece (20).

5. The vacuum extraction unit as claimed in claim 1, characterized in that the curvature of the curved directing wall (18) is exponentially curved.

6. The vacuum extraction unit as claimed in claim 1, characterized in that the opening or openings (23) through which the radiation for processing the workpiece (20) is guided is provided in the region of the curved directing wall (18) that lies closest to the surface of the workpiece (20) in the operating position of the hood (10).

7. The vacuum extraction unit as claimed in claim 2, characterized in that the contour of the end edges (19) of the side walls (16) is a polyline adapted to the contour of the workpiece surface.

8. The vacuum extraction unit as claimed in claim 2, characterized in that the contour of the end edges (19) of the side walls (16) is an arc of a circle adapted to the contour of the workpiece surface.

9. The vacuum extraction unit as claimed in claim 2, characterized in that the distance between the end edges (19) of the side walls (16) and the workpiece surface in the operating position of the hood (10) is less than 50 mm, preferably less than 30 mm, in particular less than 10 mm but greater than 0.5 mm, and with particular preference between 1 mm and 5 mm.

10. The vacuum extraction unit as claimed in claim 2, characterized in that the width of the gap seals formed between the end edges (19) of the side walls (16) and the workpiece surface lies in the range between 0.1 mm and 30 mm.

11. The vacuum extraction unit as claimed in claim 2, characterized in that the hood (10) is exchangeably fastened to a working laser head (30).

12. The vacuum extraction unit as claimed in claim 2, characterized in that the side walls (16) of the hood are provided with means, in particular movable lamellae or exchangeable side parts, by which the contour of the edges of the side walls (16) that lie opposite a workpiece (20) can be changed in order to adapt them to the surface of the workpiece (20).

13. The vacuum extraction unit as claimed in claim 1, characterized in that, in the region of the curved directing wall (18) that lies closest to the surface of the workpiece (20) in the operating position of the hood (10), each working jet or beam delivered by a processing head, in particular each working laser beam (24) delivered by a working laser head (30), is provided with an opening (23) of its own, through which the radiation for processing the workpiece (20) is focused on the latter.

14. The vacuum extraction unit as claimed in claim 1, characterized in that a C-shaped cover ring (40) which has two ends that follow the circumference of the workpiece and are located at a distance from each other and which has a substantially U-shaped cross section is provided, the hood (10) being arranged adjacent one of the two circumferential ends of the cover ring (40).

15. The vacuum extraction unit as claimed in claim 14, characterized in that the C-shaped cover ring (40) is exchangeable.

16. The vacuum extraction unit as claimed in claim 14, characterized in that the side walls (41) of the C-shaped cover ring (40) are provided with means for reducing its free inside diameter, so that said ring can be set to correspond to the diameter of the cylindrical workpiece (20) respectively to be processed.

17. The vacuum extraction unit as claimed in claim 16, characterized in that the means for reducing the free inside diameter of the C-shaped cover ring comprise a lamellar seal (48).

18. The vacuum extraction unit as claimed in claim 17, characterized in that the individual lamellae (49) of the lamellar seal (48) are pivotably fastened to the side walls (41) of the cover ring (40).

19. The vacuum extraction unit as claimed in claim 16, characterized in that the means for reducing the free inside diameter of the C-shaped cover ring comprise exchangeable side parts, in particular side plates.

20. The vacuum extraction unit as claimed in claim 14, characterized in that the C-shaped cover ring (40) is circumferentially subdivided into at least two ring segments, which are pivotably held against each other.

21. The vacuum extraction unit as claimed in claim 20, characterized in that the C-shaped cover ring a(40) is circumferentially subdivided into three ring segments of different circumferential lengths, the circumferential length of an upper ring segment corresponding approximately to half the circumferential length of the cover ring (40), while the lower ring portion has two shorter ring segments.

22. The vacuum extraction unit as claimed in claim 14, characterized in that a vacuum extraction nozzle (47) is arranged in an intermediate space between the hood (10) and a circumferential end of the C-shaped cover ring (40) that is located upstream of the hood (10).

23. The vacuum extraction unit as claimed in claim 2, characterized in that the curvature of the curved directing wall (18) is curved in the form of an arc of a circle.

24. The vacuum extraction unit as claimed in claim 2, characterized in that the curvature of the curved directing wall (18) is exponentially curved.

25. The vacuum extraction unit as claimed in claim 24, characterized in that the curving of the curvature of the curved directing wall (18) is greater than the curving of the surface of the workpiece (20).

26. The vacuum extraction unit as claimed in claim 7, characterized in that the distance between the end edges (19) of the side walls (16) and the workpiece surface in the operating position of the hood (10) is less than 50 mm, preferably less than 30 mm, in particular less than 10 mm but greater than 0.5 mm, and with particular preference between 1 mm and 5 mm.

27. The vacuum extraction unit as claimed in claim 8, characterized in that the distance between the end edges (19) of the side walls (16) and the workpiece surface in the operating position of the hood (10) is less than 50 mm, preferably less than 30 mm, in particular less than 10 mm but greater than 0.5 mm, and with particular preference between 1 mm and 5 mm.
